(19) United States
(12) Patent Application Publication
(10) Pub. No.: US 2019/0387555 A1
(43) Pub. Date: Dec. 19, 2019

(54) COMMUNICATION METHOD AND COMMUNICATION DEVICE

(71) Applicant: CHINA ACADEMY OF TELECOMMUNICATIONS TECHNOLOGY, Beijing (CN)

(72) Inventors: Yingmin WANG, Beijing (CN); Jinbo ZHAO, Beijing (CN)

(73) Assignee: CHINA ACADEMY OF TELECOMMUNICATIONS TECHNOLOGY, Beijing (CN)

(21) Appl. No.: 16/480,454

(22) PCT Filed: Feb. 7, 2018
(86) PCT No.: PCT/CN2018/075594

§ 371 Date: Jul. 24, 2019

(30) Foreign Application Priority Data
Jan. 25, 2017 (CN) 201710056241.1

(51) Int. Cl. H04W 76/10; H04L 12/24; H04W 72/12; H04W 56/00

(52) U.S. Cl. CPC H04W 76/10; H04W 56/001; H04W 72/12; H04L 41/0803

(57) ABSTRACT

A communication method and a communication device are provided. The method includes establishing a communication scene by incorporating a plurality of communication connections into the communication scene, and establishing a service association relation among the plurality of communication connections; performing scene adaption to the plurality of communication connections included in the communication scene, wherein the scene adaption includes at least one of service synchronization, resource scheduling, or connection re-establishment.

### CROSS-REFERENCE TO RELATED APPLICATION

This application claims a priority to a Chinese Patent Application No. 201710056241.1 filed in China on Jan. 25, 2017, the present disclosure of which is incorporated in their entirety by reference herein.

### TECHNICAL FIELD

The present disclosure relates to the field of communication technology, and in particular, relates to a communication method and a communication apparatus.

### BACKGROUND

Existing communication systems have multiple types. The communication systems are initially designed for a certain class of users and requirements, and use specific frequency bands and communication technologies to ensure communication qualities. In addition, system bandwidths of the communication systems are also limited. In order to ensure flexibility of scheduling resources, the existing communication systems needs to independently allocate resources for supporting multiple services in a network, and each of the services needs to be independently initiated and be provided with separate contexts and signaling. Even if different services belong to the same user, the different services belong to the same user are not correlated to each other, resulting in lower transmission efficiencies of the communication systems.

### SUMMARY

An objective of the present disclosure is to provide a communication method and a communication device, so as to address a technical problem that a communication system has low transmission efficiency.

To achieve the above objective, some embodiments of the present disclosure provide a communication method. The communication method includes: establishing a communication scene by incorporating a plurality of communication connections into the communication scene, and establishing a service association relation among the plurality of communication connections; performing scene adaption to the plurality of communication connections included in the communication scene, wherein the scene adaption includes at least one of service synchronization, resource scheduling, or connection re-establishment.

In some optional embodiments, the establishing a communication scene by incorporating a plurality of communication connections into the communication scene includes: establishing the communication scene through a human-machine interaction interface; or obtaining communication information reported by a plurality of communication devices, determining whether the plurality of communication devices belong to a same scene or not based on the communication information reported by the plurality of communication devices, and in a case that the plurality of communication devices belong to the same scene, establishing the communication scene for the plurality of communication devices.

In some optional embodiments, the obtaining communication information reported by the plurality of communication devices, determining whether the plurality of communication devices belong to the same scene or not based on the communication information reported by the plurality of communication devices, and in the case that plurality of communication devices belong to the same scene, establishing the communication scene for the plurality of communication devices, includes: obtaining the communication information reported by the plurality of communication devices, wherein the communication information includes at least one of: user identifiers, communication time information, communication location information, device type information, environment information, or service type information; determining whether the communication information reported by the plurality of communication devices matches predefined critical scene information or not; in a case that the communication information reported by the plurality of communication devices matches the predefined critical scene information, determining that the plurality of communication devices belong to the same scene, and establishing the communication scene for the plurality of communication devices, wherein the communication scene corresponds to the predefined critical scene information.

In some optional embodiments, the method further includes configuring a scene label for a plurality of communication devices within the scene.

In some optional embodiments, communication resources within the communication scene include communication resources of different operators, communication resources of different networks, communication resources of different frequency bands, communication resources of different communication technology systems and/or communication resources of different network hierarchies. The performing the scene adaption to the plurality of communication connections included in the communication scene, includes: performing the scene adaption to the plurality of communication connections included in the scene across operators, across networks, across frequency bands, across communication technology systems, and/or across network hierarchies.

In some optional embodiments, the method further includes: creating a scene template for the communication scene, wherein the scene template includes critical scene information for the communication scene, and the critical scene information is used for establishing the communication scene and/or is used for the scene adaption of the plurality of communication connections included in the scene.

In some optional embodiments, the creating the scene template for the communication scene includes: classifying and/or filtering the critical scene information in the communication scene through a human-computer interaction interface, and creating the scene template including results of the classifying and/or the filtering.

In some optional embodiments, the method further includes setting priority levels of communication devices and/or services within the communication scene, wherein the performing the scene adaption to the plurality of communication connections included in the communication scene includes: performing the scene adaption to the plurality of communication connections included in the communication scene based on the priority levels of the communication devices and/or the services within the scene.

In some optional embodiments, the service synchronization includes time synchronization and/or synchronization of security policies; and/or the resource scheduling includes configuring transmission resources for communication connections by sharing resources, bundling resources, and/or adjusting a scheduling priority level; and/or the connection re-establishment includes configuring transmission resources for the communication connections among a plurality of networks and/or the plurality of communication devices included in the communication scene if communication qualities of the communication connections satisfy a predefined re-establishment condition, and performing the connection re-establishment of the communication connections based on the transmission resources.

Some embodiments of the present disclosure further provide a communication device. The communication device includes a scene establishment module, configured to establish a communication scene by incorporating a plurality of communication connections into the communication scene, and establish a service association relation among the plurality of communication connections; an adaption module, configured to perform scene adaption to the plurality of communication connections included in the communication scene, wherein the scene adaption includes at least one of service synchronization, resource scheduling, or connection re-establishment.

In some optional embodiments, the scene establishment module is configured to establish the communication scene through a human-machine interaction interface; or the scene establishment module is configured to obtain communication information reported by a plurality of communication devices, determine whether the plurality of communication devices belong to a same scene or not based on the communication information reported by the plurality of communication devices, and in a case that the plurality of communication devices belong to the same scene, establish the communication scene for the plurality of communication devices.

In some optional embodiments, the scene establishment module includes an obtaining unit, a determination unit, and an establishment unit; the obtaining unit is configured to obtain the communication information reported by the plurality of communication devices, wherein the communication information includes at least one of user identifiers, communication time information, communication location information, device type information, environment information, or service type information; the determination unit is configured to determine whether the communication information reported by the plurality of communication devices matches predefined critical scene information or not; the establishment unit is configured to: in a case that the communication information reported by the plurality of communication devices matches the predefined critical scene information, determine that the plurality of communication devices belong to the same scene, and establish the communication scene for the plurality of communication devices, wherein the communication scene corresponds to the predefined critical scene information.

In some optional embodiments, the communication device further includes: a configuration module, configured to configure a scene label for a plurality of communication devices within the scene.

In some optional embodiments, communication resources within the above scene include communication resources of different operators, communication resources of different networks, communication resources of different frequency bands, communication resources of different communication technology systems and/or communication resources of different network hierarchies. The adaption module is configured to perform the scene adaption to communication connections included in the communication scene across operators, across networks, across frequency bands, across communication technology systems, and/or across network hierarchies.

In some optional embodiments, the communication device further includes a template creation module, configured to create a scene template for the communication scene, wherein the scene template includes critical scene information for the communication scene, and the critical scene information is used for establishing the scene and/or is used for the scene adaption of the communication connections included in the scene.

In some optional embodiments, the template creation module is configured to classify and/or filter the critical scene information in the scene through a human-machine interaction interface, and create the scene template including results of the classifying and/or the filtering.

In some optional embodiments, the communication device further includes a setting module, configured to set priority levels of communication devices and/or services within the scene, wherein the adaption module is further configured to perform the scene adaption to the communication connections included in the scene based on the priority levels of the communication devices and/or the services within the scene.

In some optional embodiments, the service synchronization includes time synchronization and/or synchronization of security policies; and/or the resource scheduling includes configuring transmission resources for communication connections by sharing resources, bundling resources, and/or adjusting a scheduling priority level; and/or the connection re-establishment includes configuring transmission resources for the communication connections among a plurality of networks and/or the plurality of communication devices included in the scene if communication qualities of the communication connections satisfy a predefined re-establishment condition, and performing the connection re-establishment of the communication connections based on the transmission resources.

Some embodiments of the present disclosure further provide a communication device. The communication device includes a processor, a transceiver, and a storage, wherein the processor is configured to read programs in the storage and execute following steps: establishing a communication scene by incorporating a plurality of communication connections into the communication scene, and establishing a service association relation among the plurality of communication connections; performing scene adaption to the plurality of communication connections included in the communication scene, wherein the scene adaption includes at least one of service synchronization, resource scheduling, or connection re-establishment, the transceiver is configured to establish communication connections, receive data and transmit data.

The above technical solutions of the present disclosure have following beneficial effects: the embodiments of the present disclosure establish a communication scene by incorporating a plurality of communication connections into the communication scene, and establish a service association relation among the plurality of communication connections; perform scene adaption to the plurality of communication connections included in the communication scene, wherein the scene adaption includes at least one of service synchronization, resource scheduling, or connection re-establishment. In this way, the communication connections having the service association relation among them are associated in a same communication scene and the scene adaption is performed to the communication connections in the scene, and thus the transmission efficiency of the communication system may be increased.

### BRIEF DESCRIPTION OF THE DRAWINGS

FIG. 1 is a flowchart of a communication method provided in the embodiments of the present disclosure;

FIG. 2 is a schematic diagram of a communication structure provided in the embodiments of the present disclosure;

FIG. 3 is another schematic diagram of a communication structure provided in the embodiments of the present disclosure;

FIG. 4 is yet another schematic diagram of a communication structure provided in the embodiments of the present disclosure;

FIG. 5 is a structural schematic diagram of a communication device provided in the embodiments of the present disclosure;

FIG. 6 is another structural schematic diagram of a communication device provided in the embodiments of the present disclosure;

FIG. 7 is yet another structural schematic diagram of a communication device provided in the embodiments of the present disclosure;

FIG. 8 is still yet another structural schematic diagram of a communication device provided in the embodiments of the present disclosure;

FIG. 9 is still yet another structural schematic diagram of a communication device provided in the embodiments of the present disclosure;

FIG. 10 is still yet another structural schematic diagram of a communication device provided in the embodiments of the present disclosure.

### DETAILED DESCRIPTION

In order to make technical problems, technical solutions and advantages to be solved by the present disclosure clearer, a detailed description will be provided hereinafter with reference to accompanying drawings and embodiments.

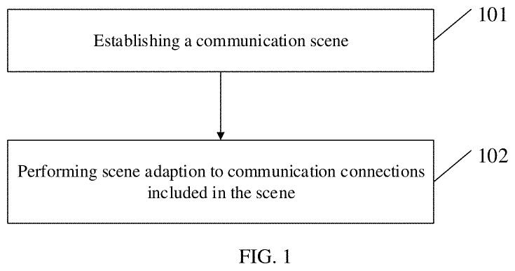

Referring to FIG. 1, some embodiments of the present disclosure provide a communication method. The communication method includes following steps 101-102, as shown in FIG. 1.

Step 101: establishing a communication scene by incorporating a plurality of communication connections into the communication scene, and establishing a service association relation among the plurality of communication connections.

Step 102: performing scene adaption to the plurality of communication connections included in the communication scene, wherein the scene adaption includes at least one of service synchronization, resource scheduling, or connection re-establishment.

In the embodiments of the present disclosure, the scene may be defined to include a set of the plurality of communication connections, and the plurality of communication connections may be a same type or different types of communication connections, or communication connections in different networks. The service association relation among the plurality of communication connections may be service associations among the plurality of communication connections, wherein the associations include, but are not limited to, a location association, a time association, a service association, a purpose association, a device association or a communication-account-number (which may also be understood as a person) association, etc. More specifically, the scene may be expressed as a person, an event, or a combination thereof (the person and the event) accomplishing one or more tasks under certain conditions, wherein the tasks herein may be understood as events that need to be performed. Thus, the scene may contain multiple associated dimensions, such as users, environments, and activities. In various specific applications, scene information of the scene may have different meanings, such as activity information, geographic-spatial information, a network state, a battery level, a social network situation, energy consumption, environmental parameters, a signal-to-noise ratio, and the like.

Additionally, the plurality of communication connections may be communication connections belonging to a plurality of communication systems, for example, communication connections including a communication connection in a Fifth Generation (5G) communication system, a communication connection in a Fourth Generation (4G) communication system, a communication connection in a Third Generation (3G) communication system, a communication connection in a satellite communication system, a communication connection in a Long Term Evolution for Vehicle (LTE-V) communication system, a communication connection in a Wireless Sensor Network (WSN) communication system, and a communication connection in a Wireless Local Area Network (WLAN) communication system, that is, communication resources in the scene include communication resources of the plurality of communication systems. Of course, the communication systems herein are merely illustrative, and in the embodiments of the present disclosure, the communication systems to which the scene relates include, but are not limited to, the communication systems listed above. Each of the communication systems in the above scene may have multiple types of traffic, and in the above scene, the same communication device may simultaneously establish connections of the same type or different types in one or more of the plurality of communication systems, so that when performing the scene adaption, advantages of heterogeneous networks are utilized, and a transmission efficiency of a entirety of the communication systems is improved.

Common examples of scenes may be a smart home, a smart power grid, an internet of vehicle, a smart building, or the like. Of course, the embodiments of the present disclosure are not limited to these examples of the scene. In the embodiments of the present disclosure, each of the scenes may include a plurality of communication connection and the plurality of communication connections are integrated together through internal service associations of the communication connections so as to accomplish certain tasks. Each of the scenes manages roles and priority levels of communication devices according to a task to be finally achieved, manages quality requirements of communication services possibly existing within the scene, and manages service association relations among the communication services within the scene. For example, each of the scenes, such as the smart home, the smart power grid, a smart transportation, the smart building, or a smart city, includes a plurality of communication connections and the plurality of communication connections are integrated together through internal service associations so as to accomplish certain tasks. After a scene is established, requirements of the tasks in the scene are not changeless with the lapse of the time and the change of the environment, but may be changed with the lapse of the time and the change of the environment.

In the embodiments of the present disclosure, the communication connections may be any communication connections in the network, and communication types, communication technology systems, communication frequency bands, operators or the like of the communication connections are not limit. That is, in the embodiments of the present disclosure, the communication connections included in a scene may be communication connections across operators, across networks, across frequency bands, across communication technology systems, and/or across network hierarchies. The communication connections may also be understood as communication services, i.e., a plurality of communication services may be included in the scene.

In addition, the above scene adaption performed to the communication connections included in the scene may be scene adaption performed to one or more communication connections of the plurality of communication connections within the scene, i.e., at least one of the service synchronization, the resource scheduling, and the connection re-establishment performed to the one or more communication connections. Additionally, the scene adaption may be performed using resources of the plurality of communication connections, so as to improve the transmission efficiency of the communication system.

In the embodiments of the present disclosure, the step 101 and the step 102 may be implemented by a functional entity, for example, a Multi-Services Management Platform (MSMP), wherein the MSMP may support management and controls of services in all communication networks related to the scene. The communication networks include, but are not limited to, mobile communication networks, wireless local area networks, satellite communication networks, wireless sensor networks, shortwave and microwave communication networks. Optionally, the MSMP may also exist in existing devices in a form of software, and may also be independent and become a new network hardware device. Whatever the MSMP is in a form of software or in a form of hardware, the MSMP may include function interfaces used for establishing connections with a plurality of networks in the scene, and information about the connections established with the plurality of networks may be obtained through the function interfaces, and procedures such as connection establishment, connection reconfiguration and connection release may be triggered based on requirements of the scene.

In addition, the above-described functional interfaces (or called network interfaces) may parse data packets and construct data packets based on various communication protocols, in order to communicate with the communication networks and the communication devices in the scene. In addition, a human-machine interaction interface in the MSMP may also be realized in following ways: active inputting at an application layer and or a network layer by a personnel, an interface of an application (APP) in a communication device, a device discovery procedure, or a confirmation through short messages, and the embodiments of the present disclosure are not limited thereto.

In addition, in the embodiments of the present disclosure, a peer-to-peer layer corresponding to the MSMP may be configured inside various communication devices supporting the scene. The peer-to-peer layer is responsible for recording scene information delivered by the MSMP, and processing relevant operations of the MSMP. From a view of implementation, this peer-to-peer layer may be an application layer of a communication device, or some application and communication management functions above the transport layer, and the embodiments of the present disclosure are not limited thereto. Of course, the communication devices may also implement the communication method provided in embodiments of the present disclosure based on relevant functions.

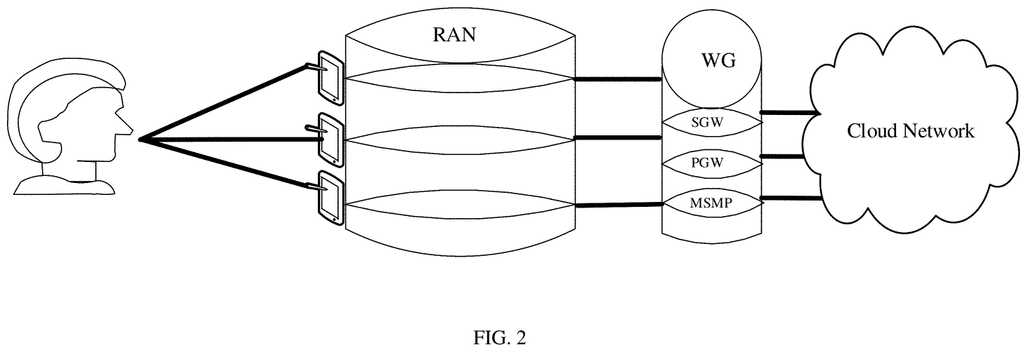

For example, as shown in FIG. 2, FIG. 2 is a diagram of a possible implementation architecture. A plurality of communication devices establishes communication connections with a gateway (GW) via a Radio Access Network (RAN). The GW includes a Serving Gate Way (SGW), a Public Data Network (PDN) Gate Way (PGW), and the MSMP. FIG. 2 illustrates the MSMP is located at the gateway. Of course, different implementations may also be performed to the devices according to respective requirements of the devices. For example, the MSMP may be independent as a functional entity such as a server, so as to facilitate manufacturing devices and upgrading networks; or the MSMP may also be arranged into a core network of a cloud so as to manage a wider range of heterogeneous networks. The MSMP may also be arranged inside access network devices so as to simplify a network hierarchy and shorten service delays.

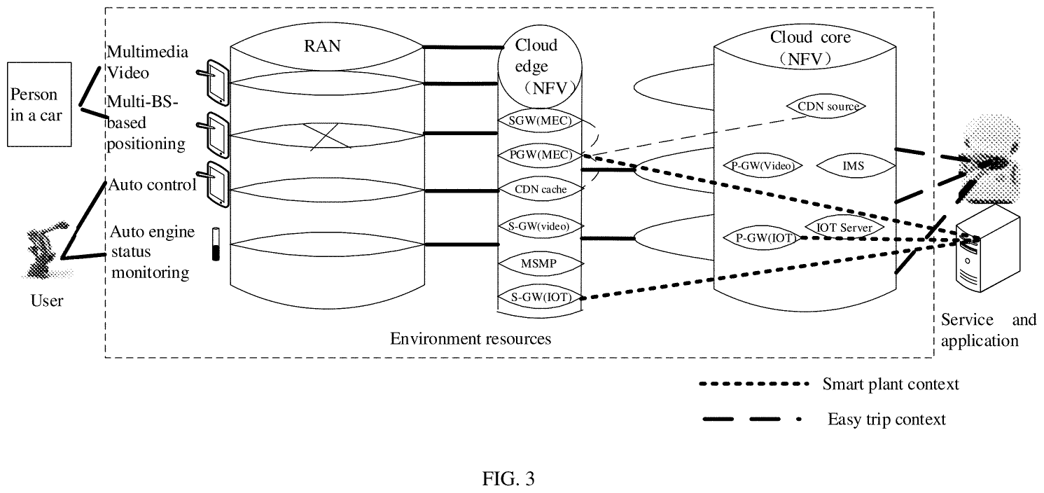

In addition, the MSMP may implement a programmable core network and a flexible air interface through a software-defined network (SDN) technique, a network function virtualization (NFV) technique, and a software-defined radio (SDR) technique. Specific implement means include performing the scene adaption through a modification of frequency bands, a modification of a frame/subframe length, a modification of modulation/demodulation and code spread-spectrum schemes and parameters, an adaption of physical-layer links, a dynamic adaption of high-layer protocol stacks, channel resource reconfigurations, a network interface adaption, a cross-layer technology or the like. For example, as shown in FIG. 3, taking the 5G network as an example, a 5G system may perform the scene adaption based on 5G context sensing.

In addition, in the embodiments of the present disclosure, a scene requiring a communication connection may be referred to as an application scene, and a communication system (a network) connecting the scene may be referred to as a network system. Under this definition, a scene sensing may be to perceive the application scene by using the network system, and the scene adaption may be to adjust the network system to be adapted to the application scene. In addition, scene changes needing to be considered in the scene adaption may also include changes of the network system itself, and the embodiments of the present disclosure are not limited thereto.

In the embodiments of the present disclosure, through the steps of establishing the scene and performing the scene adaption described above, a multi-dimensional communication based on scene requirements is completed, so that a network resource utilization and user experience may be improved. A solid foundation may be provided for an intelligent management of the network through broader connections, more plentiful data and links among the data.

In some optional embodiments, the establishing a communication scene described above includes establishing the communication scene through a human-machine interaction interface; or obtaining communication information reported by the plurality of communication devices, determining whether the plurality of communication devices belong to the same scene or not based on the communication information reported by the plurality of communication devices, and in a case that the plurality of communication devices belong to the same scene, establishing the communication scene for the plurality of communication devices.

The communication scene established through the human-machine interaction interface may be understood as a customized scene. In this embodiment, user roles and relations, security policies, device types, service types, task processing policies and the like in the scene may be defined in advance. User IDs and Device IDs may be bound together one by one through the human-machine interaction, and may be provided with a unified scene label, so that communication services initiated by the plurality of communication devices is naturally included in a communication scope of the communication scene, and the multi-dimensional communication of the communication scene is managed in a unified way. In addition, after the above scene is established, other scene information in the scene may be collected and updated through measurement reporting and information interactions of the devices in the scene, so as to enrich the scene information and improve a communication efficiency of the scene.

In this embodiment, since the communication scene may be established through the human-machine interaction interface, flexibility of the scene may be improved and needs of users may be more easily met so as to improve user experience.

Additionally, the obtaining communication information reported by the plurality of communication devices, determining whether the plurality of communication devices belong to the same scene or not based on the communication information reported by the plurality of communication devices, and in the case that the plurality of communication devices belong to the same scene, then establishing the communication scene for the plurality of communication devices may be to establish the scene established by means of scene sensing, i.e., a MSMP scene sensing module collects the information reported by the communication devices and performs a scene identification procedure. Once a corresponding scene template is obtained by matching and comparing, a corresponding scene is created, and the unified scene label is placed on the devices in the scene. Services initiated by the devices are then linked to the scene, and the multi-dimensional communication of the scene is formed and is managed in a unified manner.

In this embodiment, the scene may be established by a sensing method may be realized, so that a communication efficiency may be further improved because the scene may be established without a participation of a user.

It should be noted that in the embodiments of the present disclosure, the communication devices may be understood as communication users because the communication devices may be user terminals, and the above communication devices may also be other communication terminals, for example, a communication-enabled device such as an in-vehicle device, a wearable device, or the like. The embodiments of the present disclosure are not limited thereto. In addition, for sake of convenient description, the communication devices are described in the embodiments of that present disclosure.

In some optional embodiments, the above obtaining communication information reported by the plurality of communication devices, determining whether the plurality of communication devices belong to the same scene or not based on the communication information reported by the plurality of communication devices, and in the case that plurality of communication devices belong to the same scene, establishing the communication scene for the plurality of communication devices, includes: obtaining the communication information reported by the plurality of communication devices, wherein the communication information includes at least one of: user identifiers, communication time information, communication location information, device type information, environment information, or service type information; determining whether the communication information reported by the plurality of communication devices matches predefined critical scene information or not; in a case that the communication information reported by the plurality of communication devices matches the predefined critical scene information, determining that the plurality of communication devices belong to the same scene, and establishing the communication scene for the plurality of communication devices, wherein the scene corresponds to the predefined critical scene information.

In the embodiments, different communication devices may initiate connection establishment requests, location update requests, or synchronization requests generally to a network according to respective communication requirements. These requests may include user IDs, environmental measurement reports (a power, an interference, a path loss, a timing deviation, a temperature, a gas pressure, or a gas concentration, etc.), requested service information (including QoS), and other information (locations, security, Resource allocation). After the network side receives the request, the network side responds in time based on a current load state of the network side, or updates location information of the network side. Since a wireless network environment may change with time, measurement reporting mechanisms and accuracies of different networks and terminals are also different. Since calls of the communication devices are established randomly, time information, location information, identity information and environmental information reported by each communication device may be the same, similar or even different, and truly reflect different sides of a complex network scene, a redundancy and a correlation between the information and channels need to be comprehensively judged by the scene sensing module.

In the embodiments of the present disclosure, at least one of the user identifiers, the communication time information, the communication location information, the device type information, the environment information, and the service type information is collected through the above step, for example, a user ID, a communication initiation time, a communication location, an environment and service type, and is matched with the predefined critical scene information, wherein the matching herein may be to compare with a predefined scene information template, or search and match through key information indices, thereby identifying whether a plurality of services belong to the same scene or not. The predefined critical scene information may be critical scene information in the predefined scene information template, for example, the user identity, the communication location, the communication time, a network environment, communication devices, service activities, and an index of such information may be included in the scene information template. The user identifier may be a unique user identifier, for example, an International Mobile Subscriber Identification Number (IMSI) in a mobile communication network. Of course, the user identifier may also be identification information uniquely identifying the communication device, and embodiments of the present disclosure are not limited thereto.

Once the scene is identified, association relations are established among corresponding services, and information and resources are shared to ensure an overall experience of the communication devices in the scene. In addition, if it is found that there is a contradiction in the scene, it is judged whether there is a hidden security danger, and a report is formed and processed in time. In the embodiments of the present disclosure, from a perspective of the network, not a plurality of independent communication services is established currently, but a multi-dimensional information communication service under a certain scene is established, the independent communication services will be labeled with a common scene label and share a background, security and channel resource information. In addition, communication connections (or traffic) having high priority levels in the scene may also be bundled with connection channel resources in an entirety of the scene according to requirements of tasks in the scene so as to ensure transmission. That is, channel resources in the scene are bundled, and the bundled channel resources are used to serve the communication connection.

Similarly, after the scene is established, the MSMP may also perceive changes in the environment and user services consistently, and is responsible for recording and updating changes in the scene information so as to improve a communication performance of the scene.

It should be noted that at least one of the user identifier, the communication time information, the communication location information, the device type information, the environment information, and the service type information included in the communication information is merely illustrative. The embodiments of the present disclosure are not limited thereto. That is, the communication information may include, but is not limited to, at least one of the above information as well as other communication information.

In some optional embodiments, the method further includes configuring a scene label for the plurality of communication devices within the scene.

The communication devices herein may be communication devices corresponding to the plurality of communication connections included within the scene, and configuring the scene label for the communication devices may be to configure a unified label of the scene for the communication devices, for example, send the scene label of the communication devices to the network-side devices to which the communication devices are connected, so as to inform the network-side devices that the communication devices belong to the above-mentioned scene, and the scene label may also be transmitted to the communication devices so that communication devices are informed of the scene to which the communication devices belong.

In this embodiment, by configuring the scene label as described above, it is possible to accurately distinguish the scene to which the communication devices belong to, so as to facilitate performing the scene adaption of the scene.

In some optional embodiments, the communication resources within the above scene include communication resources of different operators, communication resources of different networks, communication resources of different frequency bands, communication resources of different communication technology systems and/or communication resources of different network hierarchies. The performing the scene adaption to the communication connections included in the scene includes performing the scene adaption to the communication connections included in the scene across operators, across networks, across frequency bands, across communication technology systems, and/or across network hierarchies.

In this embodiment, the service synchronization, the resource scheduling, and/or the connection re-establishment may be performed across operators, across networks, across frequency bands, across communication technology systems, and/or across network hierarchies, so that the transmission efficiency of the communication system may be further improved. Because, when a problem exists in a network of an operator, network resources of other operators may be scheduled for service transmission, and the service synchronization and the connection re-establishment among the operators may also be realized. However, the service synchronization, the resource scheduling and the connection re-establishment may also be performed across different network, different frequency bands, different communication technology systems and/or different layers, so as to further improve the transmission efficiency of the communication system.

In some optional embodiments, in embodiments of the present disclosure, the service synchronization includes time synchronization and/or synchronization of security policies; and/or the resource scheduling includes configuring transmission resources for communication connections by sharing resources, bundling resources, and/or adjusting a scheduling priority level; and/or the connection re-establishment includes configuring transmission resources for the communication connections among a plurality of networks and/or the plurality of communication devices included in the scene if communication qualities of the communication connections satisfy a predefined re-establishment condition, and performing the connection re-establishment of the communication connections based on the transmission resources.

Through the service synchronization described above, time synchronization and the synchronization of security policies may be implemented to a plurality of services belonging to the same scene, so as to ensure that an entirety of the information obtained by various communication means may satisfy the requirements of the scene service. The time synchronization may include a physical-layer frame synchronization and/or a network-layer frame synchronization. Of course, the time synchronization may be further extended to complete a connection establishment of a plurality of services of a plurality of networks within a certain time, and may also be further extended to ensure that transmission of the service information on corresponding connections is completed within a certain time by means of timestamps and priority scheduling. The synchronization of security policies may include an identity verification, unification of security policies, issuance and sharing of keys, and the like. In particular, the MSMP may be responsible for recording and providing synchronization information across the networks, or may provide a timing reference for a network temporarily out-of-synchronization as needed.

The above-described configuring transmission resources for communication connections through sharing resources, bundling resources and/or adjusting a scheduling priority level may be to obtain various communication resources in the scene through sharing resources, bundling resources, or adjusting the scheduling priority level, so that activated/inactivated communication channels in the scene may comprehensively provide communication services required by the scene and be adapted to the requirements of the entirety of the scene. For example, a small amount of data may also be carried over a voice-initiated communication connection using a voice activation characteristics; or an image is delivered on a voice channel by using a compression coding technique; or, after a connection is established, a high definition video is delivered by combining network load information and bundling redundant, inactivated communication channel resources in other communication networks under the scene, so as to improve experience of the scene. The bundling resources may be to bundle a plurality of resources together to transmit the same service, so as to improve the transmission efficiency.

In the embodiments of the present disclosure, in addition to a priority level of a service itself in the communication system, personalized priority-level allocation may be performed based on requirements of the scene, or a refined priority division may be performed in services of a same priority level. Although a coverage by multiple networks may be obtained under this scene, channel resources inside each of the networks are limited, and in order to meet the requirements of the scene, channel resources at different frequency bands of the same network, or channel resources at different communication modes, channel resources of networks managed by different operators may bundled. The bundled resources may be used for transmissions having high priority levels so as to provide services having a better quality. Specific implementation means include, but are not limited to, a resource scheduling, a carrier aggregation (CA), a Coordinated Multiple Points (CoMP), a Dual Link, and the like. Of course, the resource scheduling listed above is merely illustrative, and the embodiments of the present disclosure are not limited thereto.

In addition, if communication qualities of the communication connections satisfy a predefined re-establishment condition, transmission resources are configured for the communication connections between a plurality of networks and/or a plurality of communication devices included in the scene, and the connection re-establishment of the communication connections based on the transmission resources may be that qualities of one or more communication connections deteriorate due to interference, an accident or the like, or even the connections are interrupted, the connection re-establishment or the resource reconfiguration for services having high priority levels under the scene may be triggered. New channel resources may be applied between the plurality of networks identified by the scene label and a plurality of user terminals to carry the services having the high priority level, so as to ensure that key resources under this scene may be achieved. Resources are then bundled according to an abundance of channel resources and the bundled resources are then used to transmit services having a sub-high priority level.

In addition, when a communication environment is particularly deteriorated or communication resources are drastically reduced, the communication resources may not be sufficient to support the services having the high priority level originally allocated, a communication target of the scene may be re-planned and the connections of communication services may be reconfigured accordingly, so as to ensure reliable information transmission. That is, a relatively reliable communication link may be maintained to the best ability of currently available network resources, so as to transmit more communication data stably, and a specific data rate and a specific service type may be flexibly adapted.

For example, in a case that resources are sufficient, as long as a certain communication connection is in an abnormal condition, a transmission resource may be configured for the communication connection between the plurality of networks and/or the plurality of communication devices, and the connection re-establishment of the communication connection may be performed based on the transmission resource.

In addition, when the communication service terminates, each of the network devices may naturally release the connection. When a necessitated communication quality of the scene cannot be maintained since a problem such as failure of the device or interference is too serious, or an event that seriously endangers a security of a network system occurs, the problem is marked, and an insecure or unreliable network connection is actively released. Of course, the connection re-establishments listed above are only illustrative, and the embodiments of the present disclosure are not limited thereto.

The scene adaption is explained hereinafter. For example, in a scene in which a wireless environment is superior and communication network resources are sufficient, two parties in communication have established various service connections including transmissions of a high-definition video call+a satellite phone+a wireless sensor network information aggregation and reporting+a short data message so as to complete complex tasks of the scene. Multi-dimensional scene services obviously may provide a better communication experience, where wireless environment information may be shared between services, and the transmitted data may be somewhat redundant (e.g., the communication time and the communication location) and reflect details of various aspects of the scene from various perspectives.

In this scene, the scene adaption of MSMP spans Wireless Sensor Networks (WSN), short-wave communication networks, LTE-A networks and data communication networks. In the scene, a service priority level of a video stream service is higher than that of a voice service, the service priority level of the voice service is higher than that data communication, the service priority level of the data communication is higher than that of a sensor network service, and channel bandwidths allocated to the networks are also lowered in turn in correspondence to the service priority levels of the networks.

If a transmission of a network is extremely unstable due to burst interferences and a deteriorated channel environment, a service of a high-definition video stream is not sustainable any longer, an original communication network for the service may reduce a code rate of a source coding by means of a coding technology, lower a transmission rate of a channel coding by means of another code technology, use a link adaptive technology and other means to ensure that the video service may continue to be maintained; or other channels with less interference inside the network are scheduled ensure transmission of the video service.

If frequency bands of original video calls and data communication are not available any longer due to the environment being severely deteriorated, i.e., a part of resources in the communication networks may not be used normally any longer, the MSMP senses changes in the environment and the communication resources in the scene, and may bundle channel resources of the satellite communication, the data communication and the WSN in the current scene after a determination is made, and trigger a video compression coding function at an application layer of the communication device to transmit a low-rate video call service, and according to a pattern or an interval of voice bursts, insert data information and sensor network information. The communication device may schedule a peer-to-peer layer to cooperate with a network-side service to be adapted to operations of modules. Specifically, in this scene, the communication device needs to be able to decode data of one or more channels bundled together and fuse the data transmitted across the plurality of networks as needed, so as to recover respective services currently transmitted in parallel.

If satellite channel resources are insufficient, then after the MSMP collects information about current channel resources, the MSMP may adjust the task of the scene to be in an in-touch state and abandon the video service, and the voice call is the service having the highest priority level in the scene, The service adaption module will schedule and bundle available resources of all communication networks under the scene to ensure stable transmission of voice information and break the video and WSN services.

In a more extreme case, the scene adaption module may schedule all currently available communication network resources to establish a data communication connection to maintain an information connection between the two parties of the communication due to abnormal operating conditions of some of the communication devices and inability of ensuring the voice service, so as to accomplish the task of the scene.

In some optional embodiments, the method further includes creating a scene template for the scene, wherein the scene template includes critical scene information for the scene, and the critical scene information is used for establishing the scene and/or is used for the scene adaption of communication connections included in the scene.

It should be noted that this step may be performed before step 101, for example, predefining the scene template of the scene; or may be performed after step 101, that is, creating the scene template after the scene is established. The critical scene information herein may also be understood as scene information of a scene, and the scene information may be configured at the time of establishing the scene, or may be updated after the scene is established, and the embodiments of the present disclosure are not limited thereto. In addition, the critical scene information may be configured according to different requirements and/or notifications, may be defined through the human-machine interaction interface, or may be critical scene information added when the scene template is created.

In addition, creating the scene template of the above scene may also be understood as defining the scene, that is, defining scene information of the scene, so as to improve the flexibility of the scene, more adapt to service requirements, and improve an overall performance of the communication system.

In some optional embodiments, the creating the scene template of the scene includes classifying and/or filtering the critical scene information in the scene through the human-machine interaction interface, and creating the scene template including results of the classifying and/or the filtering.

The human-machine interaction interface enables a network controller and a network administrator to effectively configure tasks, user identities and permissions, device types and service information of the scene, and the like. In addition, after that above-mentioned scene template is established, the scene template may be stored for being invoked in subsequent communication and network control procedures.

Due to complex scene information in some scenes and in order to standardize definitions and facilitate usage of the scenes, the scene information may be classified to include a user scene, a physical scene, a network scene, an activity scene, a device scene and a service scene. Each of the scenes manages roles and priority levels of communication devices based on tasks to be finally achieved and user identities, manages quality requirements for communication services that may exist within the scene, and manages association relations among the communication services within the scene.

The user scene may be to define an identity of a user, a relation/a priority level of the user with other members of the scene, and a behavior of the user (i.e., the user's profile: identifications, relations with others, to do lists, etc); The identity (ID) of the user may uniquely determine the user and affect a service Quality of Service (QoS) of the communication service and security policies and parameters (such as keys) during the communication.

The physical scene may define a physical environment for activity and communication of the user, and may include, but is not limited to, a temperature, a humidity, a noise level and an interference level of the environment, a topography, a radio-signal transmission environment (The Physical Environment: humidity, temperature, noise level, etc.). The temperature, the humidity, the noise level and the interference level of the environment, the topography, the radio-signal transmission environment collectively characterize a channel of the communication.

The network scene may define a network environment for communication, and includes, but is not limited to: connectivity, a system bandwidth, a communication protocol (Network Environment: connectivity, bandwidth, protocol, etc.). The connectivity may appear as point-to-point connections, star connections, ring connections, Ad-Hoc networks, multi-hop networks, and hierarchical networks. The system bandwidth defines signal frequency bands and bandwidths used for each communication that may exist in the scene. The communication protocol then provides a language for communication within different systems.

The activity scene may define what happens to the user at what time. Time information does not have to be interpreted. Activity may be the user entering or going out of the scene (what occurs, at what time: enter, go out, etc.), or may be movement of the user within the scene.

The device scene may define profiles and activities of a device including a model number of the device, an ID, a location, a battery lifetime, and so on (The Profile and activities of Devices: identifications, locations, battery lifetime etc.).

The service scene may define information about tasks/functions that may be provided by a plurality of users, a plurality of devices and a plurality of networks within the scene, such as a function of a task (a multimedia playback, an automation control, a device detection and an environment sensing, an emergency communication, etc.) and a configuration format of the task (The information on functions which system can provide: file format, display, etc.).

In this embodiment, the critical scene information in the scene is classified and/or filtered through the human-machine interaction interface and the scene template including results of the classifying and/or the filtering is established, so that the establishment of the scene and the scene adaption may be facilitated so as to improve the performance of the communication system.

In addition, in this embodiment, in order to conveniently store and use the scene template, two implementations may be considered:

One is that, for convenience, the critical scene information of various scenes may be combed into scene features. Each of the scene features is a vector including a plurality of information features. Therefore, the scene template may be designed as a vector, and pieces of scene information collected by the network side are taken as components in different dimensions of the scene template. Then, whether or not a piece of scene information belongs to the scene may be judged by comparing an identical degree/a similarity degree between the scene information and the critical scene information; or whether or not a current part/all of users/devices belong to a certain typical scene or not may be judged by calculating a distance between vectors;

In addition, an extensible markup language (XML) technology is employed since the XML is an extensible markup language which is a source language allowing a user to define a markup language of the user. Simplicity of the XML enables the XML to be suitable to read and write data in any application. The XML is well suitable for a World Wide Web (WWW) transmission, and provides a unified way to describe and exchange structured data independent of an application or a vendor. In this way, the XML technology is used to build the scene template, so that the flexibility of the scene template may be improved to meet needs of the services in a better way, and a performance of the communication system may be improved.

Of course, if the scene information is diverse, the scene template may also be built by using a database. Of course, manners in which the scene template is created are merely illustrative, and embodiments of the present disclosure are not limited thereto.

In addition, in this embodiment, in order to meet specific requirements of various scenes, the scene information in the scene template may be added, be deleted, or be classified into different types.

In some optional embodiments, the method further includes: setting priority levels of the communication devices and/or services within the scene, wherein the performing the scene adaption to the communication connections included in the scene includes performing the scene adaption to the communication connections included in the scene based on the priority levels of the communication devices and/or the services within the scene.

In the embodiments, the priority levels of the communication devices and/or the services in the scene may be set, so that the scene adaption may be performed based on the priority levels when performing the scene adaption, so as to preferentially ensure transmissions of services with high priority levels. For example, when a transmission resource of a communication device or a service with a high priority level is abnormal, the transmission of the communication device or the service with the high priority level may be performed by scheduling or bundling transmission resources of other communication devices or services.

It should be noted that in the embodiments of the present disclosure, various optional embodiments described above may be implemented in combination with each other or may be implemented separately, and the embodiments of the present disclosure are not limited thereto. The following is illustrated by way of several specific scenes.

### First Example

This example takes the Internet of Vehicle as an example. A driver needs a map navigation service to obtain a real-time position and update a map, when the user travels by car. In order to keep good moods, passengers want to download some pieces of music from the Internet, or watch a most recent movie, so as to fill in the time of the journey. Services demanded by persons are higher-speed services and mobile broadband services in a 5G network. While the passengers enjoy the scenery, the car is in the most tense state and is using an internet-of-vehicle equipment to perform information interaction frequently with surrounding vehicles and transportation facilities. A time delay of the information interaction must be less than 10 ms. However, reliability of the information interaction needs to be not smaller than 99.999% to ensure a safety of the driving. This kind of service is a typical low-delay and high-reliability service, and takes the car as a service object. In addition, an engine of the car will report its operation status to a monitoring server in a cloud at a frequency of 4 packets per hour. Although each car reports a small amount of data, but a large number of cars will report. This kind of service requires the network to be able to provide communication connections for a large number of terminals. Users start from home, first travel through city roads, and then drive through suburban highways. In these different networking environments, a consistency of the service and a consistency of experience of the users need to be provided. Thus, in a self-driving trip scene, services having various QoS requirements are included, and a plurality of communication-enabled devices changes to a plurality of environments in an Internet-of-vehicle scene.

The users include family members, a networked car, and three smart phones (belonging to different operators), and the environments include urban roads, suburban highways, 900 MHz, 2 GHz, and 5.9 GHz; cellular communication base stations, intelligent traffic infrastructure and transmission networks. Activities include on-board information services (100 Mbps, eMBB (enhanced Mobile Broadband)), automatic control (URLLC (Ultra-Reliable Low-Latency Communications)), V-V (10 ms delay, 99.999%), V-I (10 ms, 99.999%), V-P (100 ms, 99.999%) and automatic engine status monitoring (4 packets/hour, mMTC).

The above scene provides a very desirable lifestyle. On a technical level, the Internet of Vehicle provides a complex communication task, in which a plurality of communication services with different QoS requirements are mixed, and devices initiate a plurality of service connection establishment requests, and multi-dimensional and even extreme index requirements are put forward to a design of the system.

In the embodiments of the present disclosure, by comparing scene information such as an identity, a geographical location, an initiation time point and the like reported by the service connection establishment requests, the multi-service management platform (MSMP) may identify a current scene based on a result of the comparing and a defined scene plate, and thus a scene of this Internet-of-Vehicle is established. A scene label is labelled on the users and the devices in the scene, and background information is shared among the various services. By analyzing characteristics of requirements of the various services, it may be deduced what kind of multi-dimensional communication needs to be established to meet task requirements of the scene of Internet-of-Vehicle.

Since the driver obtains real-time navigation information, this service of real-time navigation is obviously a real-time interactive service, and a priority level of this service is relatively high, but a rate of this service is not too high because road condition information and location information are not updated too quickly. A 3G network or a 4G network may ensure this service. Vehicle-vehicle interaction information functioned to ensure the driving safety will definitely be transmitted at the highest priority level, and has the extreme requirements of a low time delay and a high reliability. Thus, the vehicle-vehicle interaction information should be transmitted by means of the 5G technology or the special LTE-V technology. Mechanical information inside the vehicle may be reported through a wireless sensor network (WSN). The reporting through the WSN is simple, reliable and inexpensive. Priority levels required for recreational activities of the persons in the car are relatively low, but a communication system in the car should be provided with a high peak rate to meet transmission requirements of multimedia videos. The 4G technology or the LTE-A technology in mobile communication systems may provide such services. If there are multiple passengers in the vehicle, a small Wireless Local Area Network (WLAN) may also be established during a long-distance trip to share network resources and backhaul links. If a group of persons organize a motorcade to travel a long distance, the MSMP may also use a satellite communication or a cluster communication to ensure calls among drivers in the motocade. An amount of Information reported by a vehicle to the network periodically is generally small, that is, the service in this circumstance is a service with a small data amount and occurring frequently. A communication mechanism with less signaling overheads and supporting more users is needed to satisfy the service.

The above involves a series of networks such as 3G, 4G, 5G, LTE-V, WSN, WLAN, etc., and most of the networks already exist, and tariffs of the network are obviously different. In addition, considering deployment strategies of operators and in order to improve a resource utilization rate, reduce a cost of establishing networks, and increase incomes, a network construction mode of arranging high-frequency small cells is generally adopted in an urban area to improve the capacity of the system and provide services for more users. In suburb areas, in order to increase a coverage region, operators have generally adopted a network construction mode of low-frequency large cells, so that when driving to these areas, the communication devices also need to be switched to the networks.

It may be concluded that if a single communication system is used to establish multiple connections to serve this scene, network resources are obviously not efficiently utilized, or costs of usage are high, and a desired user experience may not be necessarily obtained. In other words, if communication networks and communication devices having high-frequency operations modes and low-frequency operation modes may be organically integrated, appropriate service connections may be established, or the communication connections may be reconfigured according to a change of the scene in time, a better scene experience may be provided for the user.

The multi-service management platform (MSMP) may maintain various services in the scene of Internet-of-Vehicle. The maintaining may include three aspects of service synchronization, resource scheduling and connection re-establishment. A satellite navigation service, a real-time road condition provision service, and a communication between a car and a roadside base station are closely related services. A uniform user tag and a uniform scene label are set by establishing a relation among the services through scene sensing. The services may provide auxiliary information (e.g., location information, wireless environment information, motion speed information) to each other, while all three services need to be located to the same car ID or the same driver ID, and the same network security policy may be used.

If the car enters a tunnel, satellite signals cannot be obtain for a short time, as shown in FIG. 3, positioning of the car is interrupted. The multi-service management platform (MSMP) is located in a cloud edge of a cloud network of Network Function Virtualization (NFV). The cloud edge of the NFV also includes a SGW, PGW (MEC) of a Mobile Edge Computing (MEC), Content Delivery Network (CDN) caching, a S-GW for videos, the MSMP and a S-GW for an Internet of Things (IoT). The cloud core may include a CDN source, a P-GW for videos, an IP multimedia subsystem (IMS), an IoT server and a P-GW for the IoT. In such a network structure, the MSMP may calculate a position of the car in combination with the road condition information and speed information between the car and the roadside base station, so as to replace the satellite position information. If the tunnel is long, the MSMP may also actively trigger establishing a new connection in the mobile communication network, or use a part of channel resources used for the original multimedia video transmission and update the location of the user in real time through a positioning service provided by nearby multiple base stations. However, since the original low priority level of a transmission service of multimedia videos may be triggered by the MSMP to reduce a transmission rate of the multimedia videos, and thus a picture quality of the multimedia videos is sacrificed to ensure transmission of services having high priority levels. Whether information transmission is replaced by other network connections, or the MSMP compensates for a missed connection of the satellite communication by bundling and reconstructing channel resources of different networks so as to complete the communication required by the scene, both cases are based on the resource scheduling and service adaption strategies under the scene.

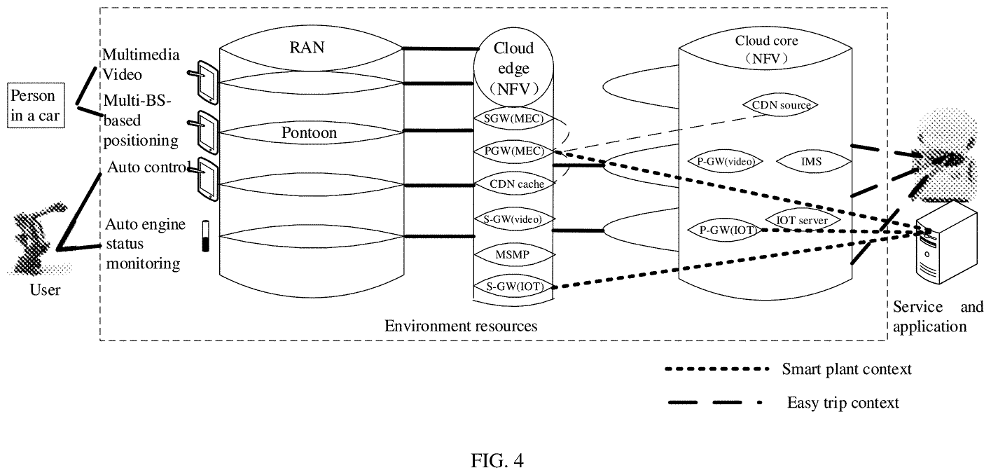

A pontoon in FIG. 4 indicates that channel resources of mobile communication networks are bundled to assist the scene of Internet-of-Vehicle to continuously obtain real-time positioning information. The MSMP performs a multi-base-station-based positioning by bundling and scheduling more channel resources of the mobile communication networks, and replaces an original satellite positioning with multi-base station positioning.

If the car exits the tunnel, the MSMP platform obtains corresponding background information through a scene sensing module and finds that a Global Positioning System (GPS) signal is received again, then the MSMP platform may trigger a user terminal to resume the satellite communication connection through a scene adaption module, and a connection establishment process in the satellite network is started. Through a service synchronous procedure, once the satellite communication connection is recovered, a satellite navigation service is reused, and the MSMP platform triggers, through a network interface, channel resources occupied by the multi-base-station-based positioning to be released by the mobile communication networks. Through bundling the released channel resources, resource reallocation is performed for the service of multimedia videos (i.e., triggering a radio bearer reconfiguration procedure in the mobile communication networks), a high-definition image quality is restored, and the high-quality service of the multimedia videos is provided for the scene of Internet-of-Vehicle.

### Second Example

This example is a scene based on security payment. For example, a Beijing user Huang received a short message (a phishing short message sent by a thief through a pseudo base station) one day, and he clicked a link in the short message. According to instructions in the link, he entered his ID card information and bank card information successively, and at the same time, his mobile phone was infected with a Trojan virus. All of the above information plus the Trojan virus enable the thief to login from Guangzhou a mobile banking or an internet banking of Huang, and changed a password of the mobile banding or the internet banking of Huang immediately. Subsequently, the thief transferred a large amount of fund. A successful transfer by the thief may be avoided by a communication scene provided by the embodiments of the present disclosure. If once a communication connection is established in the scene, the MSMP may obtain ID information, communication time, and geographical location information of a user, and historical communication information of the user is stored in the system. The MSMP may judge that the user and a mobile phone frequently used by the user are in Beijing, but another mobile phone in Guangzhou logs into the internet banking overnight, modifies the password, and then transfers a large amount of money. This abnormal behavior of the thief may incur alarm information according to a predefined process strategy in the scene adaption process and cause the connection of the thief to be released actively. At the same time, a confirmation short message is sent to a pre-stored telephone number of a bank account of the user automatically, a customer service staff of the mobile banking is notified to confirm the transfer through a call, and suspend transactions of the mobile banking and the internet banking before an account owner (Huang) further perform an identity authentication and confirms the transaction. Of course, if the above steps are to be implemented, a banking server may be provided in advance with a typical scene template when mobile banking services are customized in the banking server. It may be imagined that key information of the scene should include a user name, a bank account number, mobile phone number information and a common address. The MSMP establishes the scene through the users' operations of signing the mobile banking, matches and associates a user ID and a device ID with supported services in advance, and stores the user ID, the device ID and the supported services in a network system. In a process of defining the scene, in view of high security and confidentiality requirements of a banking business, judgment conditions for abnormal business operations may also be set in advance (for example, an identity of the account owner in this case+a mobile phone ID+business occurrence time+location+sensitive operations of a large amount of funds), so as to facilitate establishment of the scene and judgment of an abnormal event by the MSMP. Both the MSMP and a bank network management system may record time, a location and operation of each login of the user, and may provide information such as network records as evidence if required by the user.

### Third Example

This example is a scene based on emergency rescue. Assuming that four travelling partners team up to a remote desert for a cross-country trip. Each of the traveling partners carries his/her own mobile phone (belonging to different operators), a partner A of the traveling partners is also equipped with a wearable equipment for monitoring body signs such as a body temperature, a heart rate and a blood pressure due to his own safety and health considerations, and the wearable equipment is bound with his own mobile phone to form a small wireless sensor network (WSN), and a sink node of the WSN is the mobile phone. A captain B of the traveling partners carries a satellite phone, and a vehicle in which the partners sit is equipped with on-board communication services (an environment sensing service, a vehicle-vehicle communication service, a vehicle-road communication service, an in-vehicle information sensing and communication service). The MSMP may provide scene services to such a long-distance traversing scene, and a main goal of the services is to guarantee communication and security, and is stored in the MSMP as a typical scene template. The scene services provided by the MSMP have enumerated main services QoS that may be provided, and a customized scene is confirmed and established through a service contracting process. In a process of establishing the scene, identities of the partners, IDs and models of the communication devices carried by the partners, a license plate number and model of the vehicle, and IDs of all kinds of in-vehicle sensing and communication devices may be added into the scene through a human-machine interaction process. The human-machine interaction process includes actively inputting identity information of the partners and mobile phone numbers in the scene by the partners, and other sensing and communication devices may also be enrolled in the scene through short messages or network discovery functions; or a corresponding APP is installed and registered on the mobile phones, and a uniform scene label is set for persons and devices in the scene through a human-machine interaction interface. Thereafter, the MSMP may continue to set a social relation among the persons, pay attention to health statuses of the persons, etc., and share background information among all member devices. The MSMP may also set a service area based on a traversing route, and configure service and channel information for possible serving base stations and satellites in advance. According to tasks and a geographical environment of a trekking, the MSMP predefines a logic for the tasks, and constantly pay attention to influence of a desert environment on human health and safety of the persons, and set starting conditions of early warning and emergency rescue. In consideration of possibility of passing through a mobile-communication-signal blind zone, a predefined high-priority-level service may bundle all communication channels in the scene for communication,

In order to provide users with services having higher qualities, and also in consideration of profitability and cost reduction of service providers, the MSMP may also directly provide a set of devices including various mobile phones, sensors and vehicles. This scene is established in advance, and device labels have already been registered. After a user signs scene services with a service provider, the user may directly use all devices and services predefined in the scene.

Before the partners are ready to enter the desert, the partners abandoned the vehicle and walked on foot, and carried environmental monitoring and sensing devices in the vehicle. The captain B turned on a positioning function of a satellite phone and judged a current position and a direction in a route. Members in the team also communicated with their relatives and friends through the mobile phones. The satellite phone automatically enters a satellite positioning procedure after being turned on, and satellite positioning information is shared to all terminals in the scene in consideration of the environment of the desert.

Two days after entering the desert, if the partner A suddenly falls into a coma due to illness, a wearable device detects abnormal data information through sensors and generates an alarm, and gathers key information such as alarm information and physical signs to his mobile phone through the WSN network to wait for communication. However, if the mobile phone of the partner A cannot search a base station signal in the desert and cannot communicate, then according to predefined service associations, the key information is forwarded to the mobile phone of the captain B through a Bluetooth communication connection between the mobile phones, and then the captain B transmits a situation of the partner A through a satellite phone channel. The MSMP at the mobile phone side or at the network side may select to establish a connection through data communication, voice communication or multimedia communication according to abundance of channels, report this emergency event and an identity of a person in distress in time, and at the same time, send current positioning information and even environmental information (human body and environmental data collected by the sensors), and send rescue information to family members and relevant departments through the satellite phone so that external emergency rescues may be expected.

In the embodiments of the present disclosure, a communication scene may be established by incorporating a plurality of communication connections into the communication scene, and a service association relation may be established among the plurality of communication connections; the scene adaption is performed on the plurality of communication connections included in the scene, wherein the scene adaption includes at least one of service synchronization, resource scheduling, or connection re-establishment. In this way, the plurality of communication connections having the service association relations among them may be associated in the same scene, and the scene adaption may be performed to the communication connections in the scene, so that the transmission efficiency of the communication system may be improved.

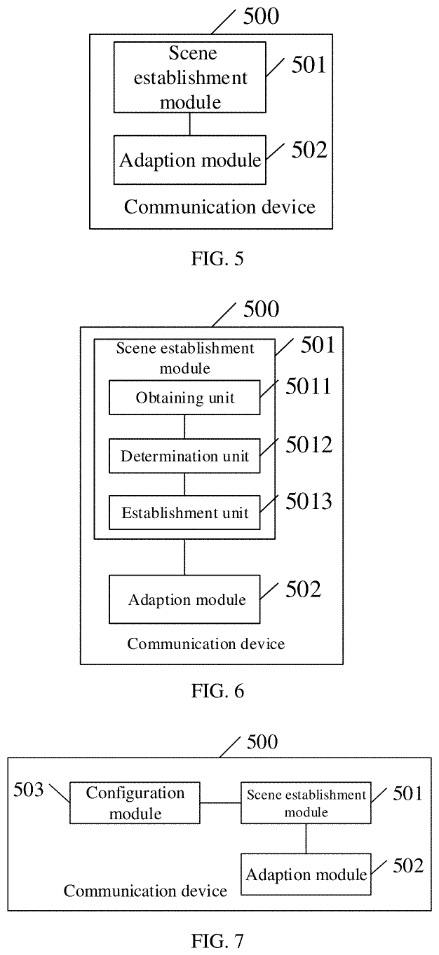

Referring to FIG. 5, some embodiments of the present disclosure provide a communication device. As shown in FIG. 5, the communication device 500 includes a scene establishment module 501, configured to establish a communication scene by incorporating a plurality of communication connections into the communication scene, and establish a service association relation among the plurality of communication connections; an adaption module 502, configured to perform scene adaption to the plurality of communication connections included in the communication scene, wherein the scene adaption includes at least one of service synchronization, resource scheduling, or connection re-establishment.

In some optional embodiments, the scene establishment module 501 is configured to establish the communication scene through a human-machine interaction interface; or the scene establishment module 501 is configured to obtain communication information reported by the plurality of communication devices, determine whether the plurality of communication devices belong to the same scene or not based on the communication information reported by the plurality of communication devices, and in a case that the plurality of communication devices belong to the same scene, establish the communication scene for the plurality of communication devices.

In some optional embodiments, as shown in FIG. 6, the scene establishment module 501 includes an obtaining unit 5011, a determination unit 5012, and an establishment unit 5013. The obtaining unit 5011 is configured to obtain the communication information reported by the plurality of communication devices, wherein the communication information includes at least one of user identifiers, communication time information, communication location information, device type information, environment information, or service type information. The determination unit 5012 is configured to determine whether the communication information reported by the plurality of communication devices matches predefined critical scene information or not. The establishment unit 5013 is configured to: in a case that the communication information reported by the plurality of communication devices matches the predefined critical scene information, determine that the plurality of communication devices belong to the same scene, and establish the communication scene for the plurality of communication devices, wherein the scene corresponds to the predefined critical scene information.

In some optional embodiments, as shown in FIG. 7, the communication device 500 further includes a configuration module 503 configured to configure a scene label for the plurality of communication devices within the scene.

In some optional embodiments, communication resources within the above scene include communication resources of different operators, communication resources of different networks, communication resources of different frequency bands, communication resources of different communication technology systems and/or communication resources of different network hierarchies. The adaption module 502 is configured to perform the scene adaption to communication connections included in the scene across operators, across networks, across frequency bands, across communication technology systems, and/or across network hierarchies.

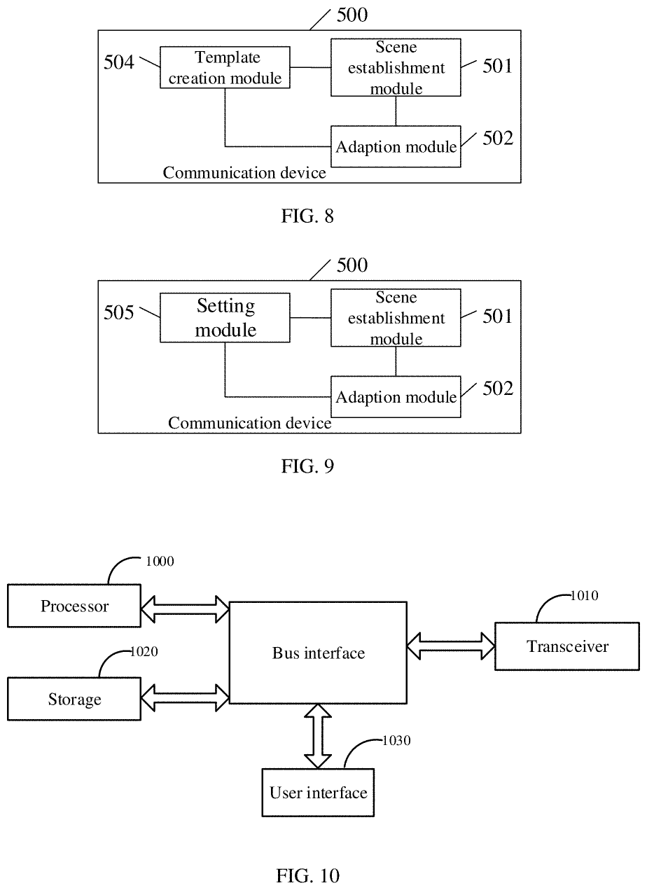

In some optional embodiments, as shown in FIG. 8, the communication device 500 further includes a template creation module 504 configured to create a scene template for the scene, wherein the scene template includes critical scene information for the scene, and the critical scene information is used for establishing the scene and/or is used for the scene adaption of the communication connections included in the scene.

In some optional embodiments, the template creation module 504 is configured to classify and/or filter the critical scene information in the scene through the human-machine interaction interface, and create the scene template including results of the classifying and/or the filtering.

In some optional embodiments, as shown in FIG. 9, the communication device 500 further includes a setting module 505 configured to set priority levels of the communication devices and/or services within the scene, wherein the adaption module 502 is further configured to perform the scene adaption to the communication connections included in the scene based on the priority levels of the communication devices and/or the services within the scene.

In some optional embodiments, the service synchronization includes time synchronization and/or synchronization of security policies; and/or the resource scheduling includes configuring transmission resources for communication connections by sharing resources, bundling resources, and/or adjusting a scheduling priority level; and/or the connection re-establishment includes configuring transmission resources for the communication connections among a plurality of networks and/or the plurality of communication devices included in the scene if communication qualities of the communication connections satisfy a predefined re-establishment condition, and performing the connection re-establishment of the communication connections based on the transmission resources.

It should be noted that the above-described communication device 500 in the present disclosure may be the MSMP in any of process embodiments of the present disclosure, any of the MSMP in the process embodiments of the present disclosure may be implemented by the communication device 500 described above in the embodiment, and a same beneficial effect may be achieved, and the description thereof will not be repeated herein.

Referring to FIG. 10, FIG. 10 shows a structure of a communication device. The communication device includes a processor 1000, a transceiver 1010, a storage 1020, a user interface 1030, and a bus interface, wherein the processor 1000 is configured to read programs in the storage 1020 to perform following steps: establishing a communication scene by incorporating a plurality of communication connections into the communication scene, and establishing a service association relation among the plurality of communication connections; performing scene adaption to the plurality of communication connections included in the communication scene through the transceiver 1010, wherein the scene adaption includes at least one of service synchronization, resource scheduling, or connection re-establishment. The transceiver 1010 is configured to transmit and receive data under a control of the processor 1000.

In FIG. 10, a bus architecture may include any number of buses and bridges connected together. Specifically, a plurality of processors such as the processor 1000 and a plurality of storages such as the storage 1020 are connected together. The bus architecture may also cause any other circuits such as a peripheral circuit, a voltage regulator and a power management circuit to be connected together. The circuits are known in the art, and thus detailed descriptions thereof are not further provided herein. The bus interface provides an interface. The transceiver 1010 may be a plurality of elements, i.e., include a transmitter and a receiver, and provide elements used to communicate with various other devices through a transmission medium. For different user terminals, the user interface 1030 may also be interfaces capable of connecting internal devices or external devices. The connected devices may include, but are not limited to, keypads, displays, speakers, microphones, operating levers, or the like.

The processor 1000 is responsible for managing the bus architecture and general processing transactions. The storage 1020 may store data used by the processor 1000 when the processor 1000 performs operations.

In some optional embodiments, the establishing a communication scene includes establishing the communication scene through a human-machine interaction interface; or obtaining communication information reported by the plurality of communication devices, determining whether the plurality of communication devices belong to the same scene or not based on the communication information reported by the plurality of communication devices, and in a case that the plurality of communication devices belong to the same scene, establishing the communication scene for the plurality of communication devices.

In some optional embodiments, the above obtaining communication information reported by the plurality of communication devices, determining whether the plurality of communication devices belong to the same scene or not based on the communication information reported by the plurality of communication devices, and in the case that plurality of communication devices belong to the same scene, establishing the communication scene for the plurality of communication devices, includes: obtaining the communication information reported by the plurality of communication devices, wherein the communication information includes at least one of user identifiers, communication time information, communication location information, device type information, environment information, or service type information; determining whether the communication information reported by the plurality of communication devices matches predefined critical scene information or not; in a case that the communication information reported by the plurality of communication devices matches the predefined critical scene information, determining that the plurality of communication devices belong to the same scene, and establishing the communication scene for the plurality of communication devices, wherein the scene corresponds to the predefined critical scene information.

In some optional embodiments, the processor 1000 is further configured for configuring a scene label for the plurality of communication devices within the scene.

In some optional embodiments, communication resources within the above scene include communication resources of different operators, communication resources of different networks, communication resources of different frequency bands, communication resources of different communication technology systems and/or communication resources of different network hierarchies. The performing the scene adaption to communication connections included in the scene, include: performing the scene adaption to communication connections included in the scene across operators, across networks, across frequency bands, across communication technology systems, and/or across network hierarchies.

In some optional embodiments, the processor 1000 is further configured for creating a scene template for the scene, wherein the scene template includes critical scene information for the scene, and the critical scene information is used for establishing the scene and/or is used for the scene adaption of the communication connections included in the scene.

In some optional embodiments of the present disclosure, the creating the scene template for the scene, includes classifying and/or filtering the critical scene information in the scene through the human-machine interaction interface, and creating the scene template including results of the classifying and/or the filtering.

In some optional embodiments, the processor 1000 is further configured for setting priority levels of the communication devices and/or services within the scene, wherein the performing the scene adaption to the communication connections included in the scene includes performing the scene adaption to the communication connections included in the scene based on the priority levels of the communication devices and/or the services within the scene.

In some optional embodiments, the service synchronization includes time synchronization and/or synchronization of security policies; and/or the resource scheduling includes configuring transmission resources for communication connections by sharing resources, bundling resources, and/or adjusting a scheduling priority level; and/or the connection re-establishment includes configuring transmission resources for the communication connections among a plurality of networks and/or the plurality of communication devices included in the scene if communication qualities of the communication connections satisfy a predefined re-establishment condition, and performing the connection re-establishment of the communication connections based on the transmission resources.

It should be noted that the above-described communication device in the present disclosure may be the MSMP in any of process embodiments of the present disclosure, any of the MSMP in the process embodiments of the present disclosure may be implemented by the communication device described above in the embodiment, and a same beneficial effect may be achieved, and the description thereof will not be repeated herein.

It should be understood that, in several embodiments provided in the present disclosure, the disclosed device and method may be implemented in other ways. The apparatus embodiments described above are only illustrative. For example, a division of units may be only one logically functional division. There may be other divisions in actual implementations, e.g, multiple units or components may be combined or integrated in another system, or some features may be omitted or not executed. Additionally, couplings, or direct couplings, or communication connections between displayed or discussed components may be indirect couplings or communication connections via some interfaces, devices or units and may be electrical connections, mechanical connections or other forms of connections.

The functional units described in the embodiments of the present disclosure may be integrated in one processing unit or may be separated physically, or two or more of the units may be integrated in one unit. The above integrated units may be implemented by hardware, or a functional unit including hardware and software.

The above integrated units implemented by functional units including software may be stored in a computer readable storage medium. The functional units including software stored the medium may include instructions for causing a computing device (which may be a personal computer, a server, a network device or the like) to perform some or parts of the method of the embodiments of the present disclosure. The storage medium may include mediums capable of storing codes, such as a USB disk, a removable disk, a Read Only Memory (ROM), a Random Access Memory (RAM), a Magnetic Disk, a Compact Disk, or the like. The medium may be a volatile storage medium or a non-volatile storage medium.

The above described embodiments of the present disclosure are optional embodiments. It should be noted that numerous modifications and embellishments may be made by one of ordinary skills in the art without departing from the spirit of the present disclosure, and such modifications and embellishments also fall within the scope of the present disclosure.

1. A communication method, comprising:
establishing a communication scene by incorporating a plurality of communication connections into the communication scene, and establishing a service association relation among the plurality of communication connections;
performing scene adaption to the plurality of communication connections comprised in the communication scene, wherein the scene adaption comprises at least one of service synchronization, resource scheduling, or connection re-establishment.

2. The method according to claim 1, wherein, the establishing a communication scene by incorporating a plurality of communication connections into the communication scene, comprises:
establishing the communication scene through a human-machine interaction interface; or
obtaining communication information reported by a plurality of communication devices, determining whether the plurality of communication devices belong to a same scene or not based on the communication information reported by the plurality of communication devices, and in a case that the plurality of communication devices belong to the same scene, establishing the communication scene for the plurality of communication devices.

3. The method according to claim 2, wherein the obtaining communication information reported by the plurality of communication devices, determining whether the plurality of communication devices belong to the same scene or not based on the communication information reported by the plurality of communication devices, and in the case that plurality of communication devices belong to the same scene, establishing the communication scene for the plurality of communication devices, comprises:
obtaining the communication information reported by the plurality of communication devices, wherein the communication information comprises at least one of: user identifiers, communication time information, communication location information, device type information, environment information, or service type information;
determining whether the communication information reported by the plurality of communication devices matches predefined critical scene information or not;
in a case that the communication information reported by the plurality of communication devices matches the predefined critical scene information, determining that the plurality of communication devices belong to the same scene, and establishing the communication scene for the plurality of communication devices, wherein the communication scene corresponds to the predefined critical scene information.

4. The method according to claim 1, further comprising:
configuring a scene label for a plurality of communication devices within the scene.

5. The method according to claim 1, wherein communication resources within the communication scene comprise communication resources of different operators, communication resources of different networks, communication resources of different frequency bands, communication resources of different communication technology systems and/or communication resources of different network hierarchies;
the performing the scene adaption to the plurality of communication connections comprised in the communication scene, comprises:
performing the scene adaption to the plurality of communication connections comprised in the scene across operators, across networks, across frequency bands, across communication technology systems, and/or across network hierarchies.

6. The method according to claim 1, further comprising:
creating a scene template for the communication scene, wherein the scene template comprises critical scene information for the communication scene, and the critical scene information is used for establishing the communication scene and/or is used for the scene adaption of the plurality of communication connections comprised in the scene.

7. The method according to claim 6, wherein, the creating the scene template for the communication scene comprises:
classifying and/or filtering the critical scene information in the communication scene through a human-computer interaction interface, and creating the scene template comprising results of the classifying and/or the filtering.

8. The method according to claim 1, further comprising:
setting priority levels of communication devices and/or services within the communication scene,
wherein the performing the scene adaption to the plurality of communication connections comprised in the communication scene comprises:
performing the scene adaption to the plurality of communication connections comprised in the communication scene based on the priority levels of the communication devices and/or the services within the scene.

9. The method according to claim 1, wherein, the service synchronization comprises time synchronization and/or synchronization of security policies; and/or
the resource scheduling comprises configuring transmission resources for communication connections by sharing resources, bundling resources, and/or adjusting a scheduling priority level; and/or
the connection re-establishment comprises configuring transmission resources for the communication connections among a plurality of networks and/or the plurality of communication devices comprised in the communication scene if communication qualities of the communication connections satisfy a predefined re-establishment condition, and performing the connection re-establishment of the communication connections based on the transmission resources.

10. A communication device, comprising:
a scene establishment module, configured to establish a communication scene by incorporating a plurality of communication connections into the communication scene, and establish a service association relation among the plurality of communication connections;
an adaption module, configured to perform scene adaption to the plurality of communication connections comprised in the communication scene, wherein the scene adaption comprises at least one of service synchronization, resource scheduling, or connection re-establishment.

11. The communication device according to claim 10, wherein the scene establishment module is configured to establish the communication scene through a human-machine interaction interface; or
the scene establishment module is configured to obtain communication information reported by a plurality of communication devices, determine whether the plurality of communication devices belong to a same scene or not based on the communication information reported by the plurality of communication devices, and in a case that the plurality of communication devices belong to the same scene, establish the communication scene for the plurality of communication devices.

12. The communication device according to claim 11, wherein, the scene establishment module comprises an obtaining unit, a determination unit, and an establishment unit;
the obtaining unit is configured to obtain the communication information reported by the plurality of communication devices, wherein the communication information comprises at least one of user identifiers, communication time information, communication location information, device type information, environment information, or service type information;
the determination unit is configured to determine whether the communication information reported by the plurality of communication devices matches predefined critical scene information or not;
the establishment unit is configured to: in a case that the communication information reported by the plurality of communication devices matches the predefined critical scene information, determine that the plurality of communication devices belong to the same scene, and establish the communication scene for the plurality of communication devices, wherein the communication scene corresponds to the predefined critical scene information.

13. The communication device according to claim 10, further comprising:
a configuration module, configured to configure a scene label for a plurality of communication devices within the scene.

14. The communication device according to claim 10, wherein, communication resources within the above scene comprise communication resources of different operators, communication resources of different networks, communication resources of different frequency bands, communication resources of different communication technology systems and/or communication resources of different network hierarchies;
the adaption module is configured to perform the scene adaption to communication connections comprised in the communication scene across operators, across networks, across frequency bands, across communication technology systems, and/or across network hierarchies.

15. The communication device according to claim 10, further comprising:
a template creation module, configured to create a scene template for the communication scene, wherein the scene template comprises critical scene information for the communication scene, and the critical scene information is used for establishing the scene and/or is used for the scene adaption of the communication connections comprised in the scene.

16. The communication device according to claim 15, wherein, the template creation module is configured to classify and/or filter the critical scene information in the scene through a human-machine interaction interface, and create the scene template comprising results of the classifying and/or the filtering.

17. The communication device according to claim 10, further comprising:
a setting module, configured to set priority levels of communication devices and/or services within the scene,
wherein the adaption module is further configured to perform the scene adaption to the communication connections comprised in the scene based on the priority levels of the communication devices and/or the services within the scene.

18. The communication device according to claim 10, wherein, the service synchronization comprises time synchronization and/or synchronization of security policies; and/or
the resource scheduling comprises configuring transmission resources for communication connections by sharing resources, bundling resources, and/or adjusting a scheduling priority level; and/or
the connection re-establishment comprises configuring transmission resources for the communication connections among a plurality of networks and/or the plurality of communication devices comprised in the scene if communication qualities of the communication connections satisfy a predefined re-establishment condition, and performing the connection re-establishment of the communication connections based on the transmission resources.

19. A communication device, comprising:
a processor, a transceiver, and a storage, wherein the processor is configured to read programs in the storage and execute following steps:
establishing a communication scene by incorporating a plurality of communication connections into the communication scene, and establishing a service association relation among the plurality of communication connections;
performing scene adaption to the plurality of communication connections comprised in the communication scene, wherein the scene adaption comprises at least one of service synchronization, resource scheduling, or connection re-establishment,
the transceiver is configured to establish communication connections, receive data and transmit data.

20. The method according to claim 3, wherein, the plurality of communication devices and a device obtaining the communication information reported by the plurality of communication devices are peer devices in the communication scene.

21. The communication device according to claim 13, wherein, the communication device and the plurality device in the communication scene are peer devices in the communication scene.
